(19) United States
(12) Patent Application Publication
(10) Pub. No.: US 2007/0064643 A1
(43) Pub. Date: Mar. 22, 2007

(54) System and Method for Communication Mode Selection in Wireless Local Area Networks

(75) Inventor: Clifford Tavares, San Carlos, CA (US)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(73) Assignee: HITACHI, LTD., Tokyo (JP)

(21) Appl. No.: 11/162,639

(22) Filed: Sep. 16, 2005

(51) Int. Cl. H04Q 7/00

(52) U.S. Cl. 370/328; 370/333

(57) ABSTRACT

A system selects a communication mode in a wireless local area network. The system comprises a mode evaluator for evaluating a first attribute of an access point communication mode between a source device and a sink device, evaluating a second attribute of a direct access communication mode between the source device and the sink device, and selecting one of the access point communication mode and the direct access communication mode based on the evaluation results; and configuration information for using the selected mode.

### TECHNICAL FIELD

This invention relates generally to wireless networks, and more particularly provides a system and method for communication mode selection in wireless networks.

### BACKGROUND

Wireless local area networks, comprising a plurality of mobile stations such as mobile phones, computers, etc., can communicate among themselves as well as through a network server. Communication is typically available in two ways, namely, via an access point connection (e.g., 802.11e DCF and PCF modes) and via a direct access connection (e.g., 802.11e Direct Link mode).

802.11e as of July 2005 is a draft standard that defines a set of Quality of Service enhancements for LAN applications, in particular the 802.11 WiFi standard. The standard is considered of critical importance for delay-sensitive applications, such as Voice over Wireless IP and Streaming Multimedia. This standard typically uses an access point connection.

An access point connection connects stations (e.g., computers) via an access point (e.g., a communication server). The access point typically knows the addresses and communication protocols for communicating with each node over which it manages. When a first station wishes to communicate with a second station, the first station contacts the access point and requests communication with the second station. The access point establishes a connection with the first station and with the second station, and acts as the intermediary for all communications, e.g., data and control. Example access point mechanisms include enhanced point coordinated functions (e.g., HCCA, PCF) and enhanced distributed coordination functions (e.g., EDCA, DCF).

The basic 802.11 MAC layer uses the Distributed Coordination Function (DCF) to share the medium between multiple stations. DCF relies on CSMA/CA and optional 802.11_RTS/CTS to share the medium between stations. This has several limitations:
if many stations communicate at the same time, many collisions will occur, which will lower the available bandwidth (just like in Ethernet, which uses CSMA/CD).
there is no notion of high or low priority traffic.
once a station “wins” access to the medium, it may keep the medium for extended period of time. If a station has a low bitrate (1 Mbit/s, for example), then it will take a long time to send its packet, and all other stations will suffer from that.
more generally, there are no quality of service guarantees.

The original 802.11 MAC defined another coordination function called the Point Coordination Function (PCF): this is available only in “infrastructure” mode, where stations are connected to the network through an access point. This mode is optional, and only very few access points or Wi-Fi adapters actually implement it. Access points send “beacon” frames at regular intervals (usually every 0.1 second). Between these beacon frames, PCF defines two periods: the contention free period and the contention period. In the contention period, the DCF is simply used. In the contention free period, the access point sends Contention Free-Poll (CF-Poll) packets to each station, one at a time, to give them the right to send a packet. The access point is the coordinator. This allows for a better management of the quality of service. Unfortunately, the PCF has limited support and a number of limitations (for example, it does not define traffic classes).

The 802.11e enhances the DCF and the PCF, through two new coordination functions: the Enhanced DCF (EDCF) and the Hybrid Coordination Function (HCF) (the HCF could have been called the Enhanced PCF). Both EDCF and HCF define traffic classes. For example, emails could be assigned to a low priority class, and Voice over Wireless IP (VOWIP) could be assigned to a high priority class.

With EDCF, high priority traffic has a higher chance of being sent than low priority traffic. A station with high priority traffic waits a little less before it sends its packet, on average, than a station with low priority traffic. There are no real guarantees. It is a “best effort” quality of service. Since it is quite simple to configure and implement, a lot of people seem to choose this coordination function.

The HCF works a lot like the PCF. The interval between two beacon frames is divided into two periods, the contention free period and the contention period. During the contention free period, the hybrid coordinator (typically, the access point) controls the access to the medium. During the contention period, all stations function in EDCF. The main difference with the PCF is that traffic classes are defined. Also, the hybrid coordinator can coordinate the traffic in any fashion it chooses (not just round-robin). Moreover, the stations give info about the lengths of their queues for each traffic class. The hybrid coordinator can use this information to give priority to one station over another. Another difference is that stations are given a Transmit Opportunity (TXOP). They may send multiple packets in a row, for a given time period selected by the hybrid coordinator. During the contention period, the hybrid coordinator may chose to resume control of the access to the medium by sending CF-Poll packets to stations. In short, HCF is the most advanced (and complex) coordination function. With the HCF, quality of service can be configured with great precision. Things like bandwidth control, fairness between stations, classes of traffic, jitter, and much more can be configured within the hybrid coordinator.

Any 802.11e compatible access point must have both EDCF and HCF support. The difference between 802.11e access points will be in the configuration of the quality of service for different traffic classes. Some may actually only provide very simple bandwidth control configuration, other may go way further and offer jitter control, etc.

FIG. 1 illustrates a prior art access point network 100. Network 100 includes a first station (“Station 1”} coupled via an access point 110 to a second station (“Station 2”). The first station 105 is referred to as a “Source” because, in this example, it initiates the request for transfer of data 120. The second station 115 is referred to as a “Sink” because, in this example it receives the transfer of data 120. As shown, the first station 105 requests the access point 110 to enable a data transfer event to the second station 115. The access point 110 establishes a connection with the second station 115. The first station 205 then transfers data 120 to the access point 110, which transfers the data 120 to the second station. Although not shown, one skilled in the art knows that data 120 may transfer in both directions.

IBSS, Independant Basic Service Set, is the most basic type of IEEE 802.11 wireless LAN. Unlike infrastructure mode, all stations in the IBSS are capable of communicating directly with each other, without an access point.

In one example direct access protocol, an access point communicates with at least one of the plurality of communicating nodes to establish the direct connections (but not for data transfer). All data communications between the nodes occurs without or with limited communication to the access point. For example, when a first computer wishes to communicate with a second computer, the first computer contacts the access point. The access point provides control information for enabling direct access between the first computer and the second computer. Such a network is often referred to as “peer-to-peer.” In another example direct access protocol (e.g., IBSS mode), no access point is needed for configuration. Such a network is often referred to as “ad hoc.”

FIG. 2 illustrates a prior art “peer-to-peer” type direct access network 200. Network 200 includes a first station 205 coupled via an access point to a second station 215 and directly to the second station 215 (although not necessarily at the same time or at all times). The first station 205 request the access point to establish a data transfer event to the second station 215. The access point 210 obtains and provides control information 220 to the first station 205 and control information 225 to the second station 215. The first station 205 uses the control information 220 and second station 215 uses the control information 225 to establish a direct connection with each other. Using the direct connection, the first station 205 transfers data 230 to the second station 215. Although not shown, one skilled in the art will recognize that data can be transferred in both directions. Further, although indicated as a “direct” connection, one skilled in the art will recognize that the “direct” connection may include intermediate nodes. In this embodiment, the connection is referred to as “direct” because it does not require the access point 210 for data transfer.

Networks are preconfigured to operate either via an access point mechanism or via a direct access mechanism.

Example prior art includes protocols as described in the following IEEE articles:

[1] IEEE 802.11-04/0889r3, TGn Sync Proposal Technical Specification

[2] IEEE P802.11e/D13.0, January 2005

[3] IEEE Wireless LAN Edition, A compilation based on IEEE Std 802.11TM-1999(R2003) and its amendments, IEEE press

### SUMMARY

Each of an access point connection and direct access have benefits and detriments. Example benefits of an access point connection may include a simple design, a longer range of communication, thinner stations, etc. An example detriment of an access point connection may include slower speeds since an additional hop is needed. Example benefits of direct access may include faster throughput (theoretically, double) and reduced latency. Example detriments of direct access may include more complex design, a localized range of communication, and thicker stations.

Automatic mode selection is not part of today's WLAN standards and current networks. Selection of the communication mode is either meant to be user selective or pre-configured into the system. Even a pre-designed configuration will not perform best under changing network or application-related operating conditions. Further, when integrating WLAN support into a consumer electronics application, a user configuration free design is most desirable.

A technique in accordance with an embodiment of the present invention automatically selects the communication mode, e.g., via access point or direct access. Benefits of an automatic selection include automatic (e.g., unsupervised) configuration for best performance (possibly invoked periodically), easy operation for the user, and higher throughput/performance.

In accordance with one embodiment, the present invention provides a method for selecting a communication mode in a wireless local area network. The method includes evaluating a first attribute of an access point communication mode between a source device and a sink device; evaluating a second attribute of a direct access communication mode between the source device and the sink device; and selecting one of the access point communication and the direct access communication based on the evaluation results.

In accordance with another embodiment, the present invention provides a system for selecting a communication mode in a wireless local area network. The system includes a mode evaluator for evaluating a first attribute of an access point communication mode between a source device and a sink device, evaluating a second attribute of a direct access communication mode between the source device and the sink device, and selecting one of the access point communication mode and the direct access communication mode based on the evaluation results; and configuration information for using the selected mode.

In either embodiment, the access point communication mode and/or the direct access communication mode may be an 802.11e standard. The first and second attributes may be the same. Example attributes includes throughput rate, jitter, delay, power use, noise, cost, etc.

### BRIEF DESCRIPTION OF THE DRAWINGS

FIG. 1 illustrates a prior art access point network.

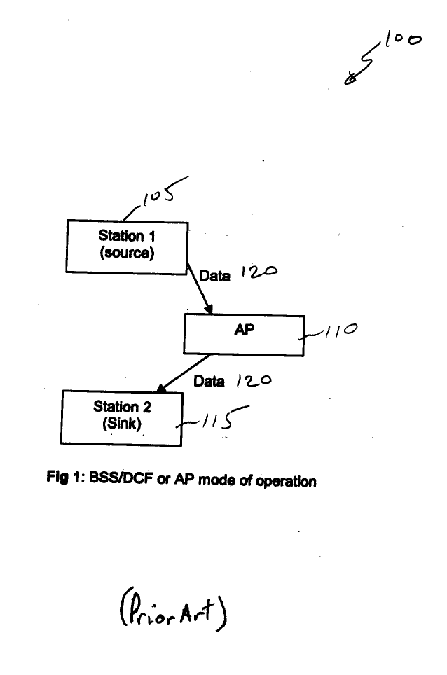

FIG. 2 illustrates a prior art “peer-to-peer” type direct access network.

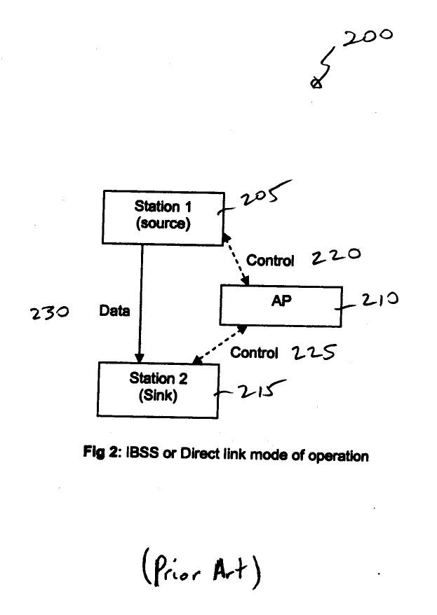

FIG. 3 is a block diagram of a communication network in accordance with an embodiment of the present invention.

FIG. 4 is a block diagram illustrating an example mode management module, in accordance with an embodiment of the present invention.

FIG. 5 is a flowchart illustrating an example evaluation method for selecting one of an access point communication mode or a direct access mode.

FIG. 6 illustrates a state machine having two stages, namely, transmission mode and configuration mode, in accordance with an embodiment of the present invention.

FIG. 7 is a block diagram illustrating a computer system in accordance with an embodiment of the present invention.

### DETAILED DESCRIPTION

The following description is provided to enable any person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

Each of an access point connection and direct access have benefits and detriments. Example benefits of an access point connection may include a simple design, a longer range of communication, thinner stations, etc. An example detriment of an access point connection may include slower speeds since an additional hop is needed. Example benefits of direct access may include faster throughput (theoretically, double) and reduced latency. Example detriments of direct access may include more complex design, a localized range of communication, and thicker stations.

Automatic mode selection is not part of today's WLAN standards and current networks. Selection of the communication mode is either meant to be user selective or pre-configured into the system. Even a pre-designed configuration will not perform best under changing network or application-related operating conditions. Further, when integrating WLAN support into a consumer electronics application, a user configuration free design is most desirable.

A technique in accordance with an embodiment of the present invention automatically selects the communication mode, e.g., via access point or direct access. Benefits of an automatic selection include automatic (e.g., unsupervised) configuration for best performance (possibly invoked periodically), easy operation for the user, and higher throughput/performance.

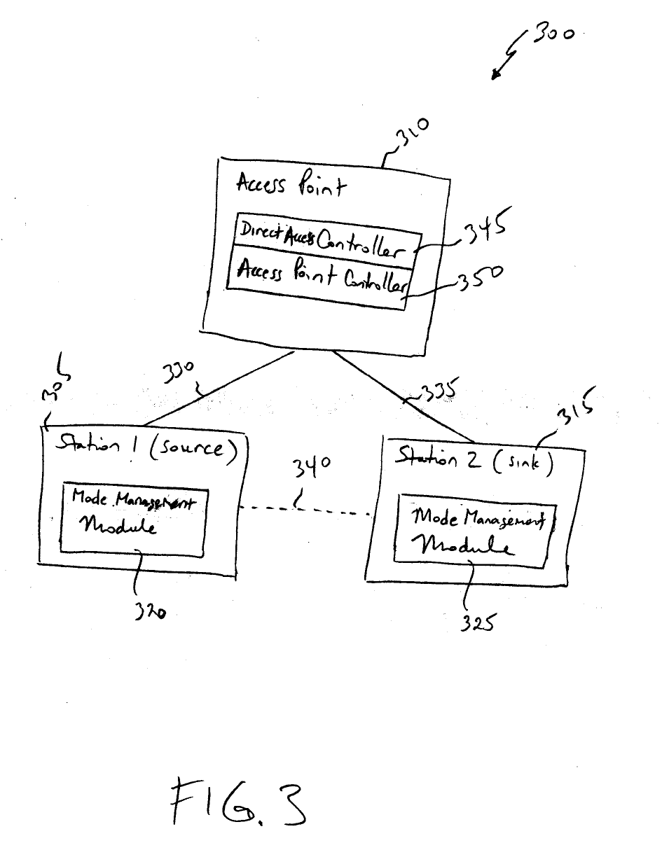

FIG. 3 is a block diagram of a communication network 300 in accordance with an embodiment of the present invention. Network 300 includes a first station 305 (“station 1”), an access point 310 and a second station 315 (“station 2”). Since various connection mechanisms are possible, links 330, 335 and 340 coupling the first station 305, the second station 315 and the access point 310 are shown, although each or all of links 330, 335 and 340 may not exist at all times. When connected, link 330 couples the first station 305 to the access point 310, link 335 couples the access point 310 to the second station 315, and link 340 couples the first station 305 to the second station 315. In this figure, the first station 305 is shown as the source, and the second station 315 is shown as the sink, although the opposite is also possible. It will be appreciated that links 330 and 335 may exist at all times for access point type data communication and during “peer-to-peer” direct access control information communication. Similarly, link 340 may exist during “peer-to-peer” direct access control information communication, and may not exist during access point data communication. For convenience, “direct access” herein refers to “peer-to-peer” type direct access, although embodiments can be developed with also enable automatic selection of an ad hoc type direct access mode of communication.

Access point 310 includes a direct access controller 345 and an access point controller 350. Direct access controller 345 enables peer-to-peer type direct access communication between the first station 305 and the second station 315. The direct access controller 345 may include conventional control information management functions to enable direct communication between the first station 305 and the second station 315 via the link 340. The access point controller 350 enables access point communication between the first station 305 and the second station 315 via the link 330, access point 310 and link 335. The access point controller 350 may include conventional data communication functions to enable access point communication between the first station 305 and the second station 315.

Each of the first station 305 and the second station 315 includes a mode management module 320 and 325, respectively. Each of mode management module 320 and 325 may be identical. Mode management module 320/325 determines the “best” mode for communicating between the first station 305 and the second station 315.

The mode management module 320/325 may select the best communication mode based on one or more attributes, such as signal quality estimation between communicating stations, throughput, link performance estimation, a link quality estimation established from metrics like signal-to-noise ratio, fading parameters, open loop and close loop estimation, etc. Attributes such as these can be measured for an access point connection and direct access, and compared. The mode management module 320/325 may select the link that offers or seems to offer the best operational parameters.

In case of comparable throughput, application driven criteria may be used to determine the selection of the link. The function F(T1, T2, D1, D2) represents an implementation of the application criteria for selection between two links with throughput T1 (throughput of link 1), T2 (throughput of link 2), delay D1 (delay of link 1) and D2 (delay of link 2), respectively. If jitter is of greater importance, an alternative function F1(T1, T2, J1, J2) may be implemented. (J1 refers to jitter of link 1; J2 refers to jitter of link 2.) If operation power is of importance, for example in a mobile battery-driven application, an alternative function F2(T1, T2, P1, P2) may be implemented. (P1 refers to power used by link 1; P2 refers to power used by link 2.) More complex functions, e.g., using different combinations of the above functions and/or other functions (e.g., cost), may also be implemented.

For most general devices, a mode selection analysis by the mode management module 320/325 may implement throughput evaluation. For home media devices, a mode selection analysis by the mode management module 320/325 may implement a throughput and delay evaluation or a throughput and jitter evaluation. For mobile devices, a mode selection analysis by the mode management module 320/325 may implement a throughput and power evaluation. For more custom/critical environments, a mode selection analysis by the mode management module 320/325 may implement more complex functions.

In the case of fixed terminals, e.g., when the channel and operating characteristics are well known, a static configuration computation may be implemented to ensure best sustained performance. In the case of a mobile or a dynamic environment, e.g. in case of a significant fading channel, the configuration computation may be dynamic and/or examined periodically by the mode management module 320/325.

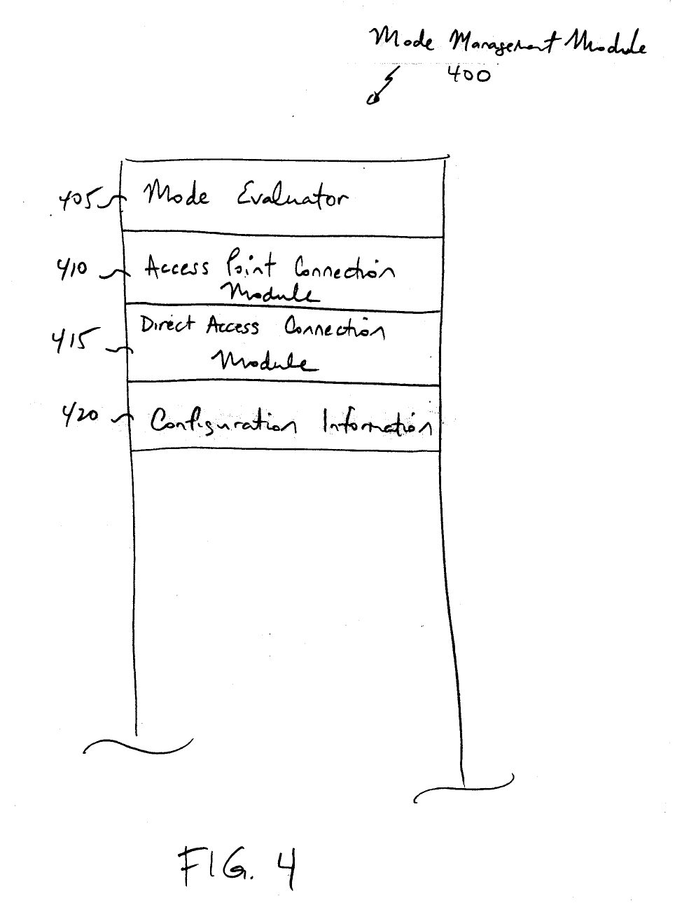

FIG. 4 is a block diagram illustrating an example mode management module 400, in accordance with an embodiment of the present invention, of which each of module 320 and 325 may be an instance. Mode management module 400 includes a mode evaluator 405, an access point connection module 410, a direct access connection module 415, and configuration information 420.

The mode evaluator 405 evaluates, compares and selects the best mode of operation based on predetermined criteria. The mode evaluator 405 may examine throughput, jitter, noise, signal strength, cost, and/or other attributes. The mode evaluator 405 applies the predetermined criteria to select the mode to use. The predetermined criteria may be set by the programmer, the system administrator, the user, etc. The mode evaluator 405 may conduct its analysis once, periodically, upon detection of predetermined events, upon request, etc.

The access point connection module 410 performs the operations to establish a connection with the access point 310 (whether as the source or the sink). Using the connection, the first station 305 can forward data to the second station 315.

The direct access connection module 415 of one station performs operations to establish a connection with the other station. The direct access connection module 415 may communicate with the access point 310 to make data transfer requests and obtain control information, e.g., control information 220. The direct access connection module 415 stores the control information as configuration information 420. One skilled in the art will recognize that the configuration information 420 may include other control information for enabling communication, whether using access point communication techniques, peer-to-peer direct access communication techniques, ad hoc direct access communication techniques, or other communication techniques.

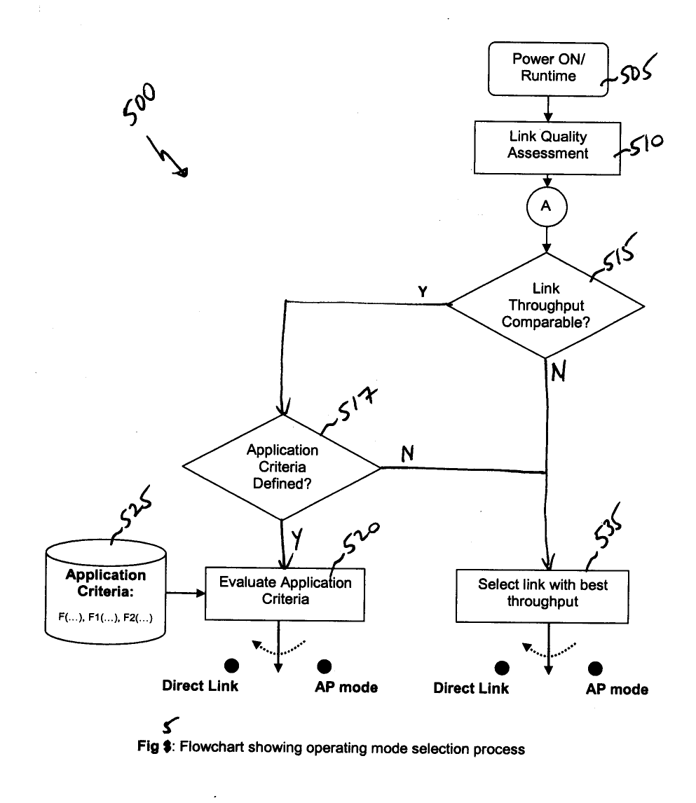

FIG. 5 is a flowchart illustrating an example evaluation method 500 for selecting one of an access point communication mode or a direct access mode. In this embodiment, method 500 begins at power-on/runtime 505 by assessing 510 link quality. Method 500 compares 515 the link throughput of the access point communication mode against the link throughput of the direct access mode. If comparable, then method 500 determines 517 whether the application criteria have been defined. If so, then method 500 evaluates 520 application criteria 525. Based on the application criteria, the method 500 selects the mode. If the throughput is not comparable or the application criteria are not defined, then method 500 selects 535 the link with the best throughput. Method 500 then ends.

It should be appreciated that, in this or a different embodiment, a method could bypass the throughput comparison and jump directly to the application criteria evaluation.

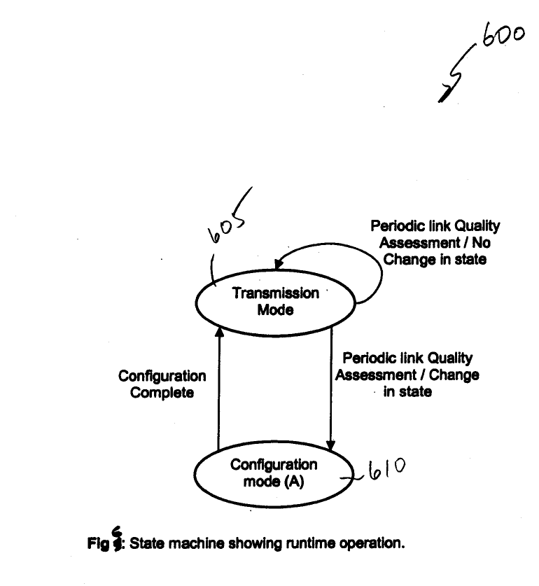

FIG. 6 illustrates an example state machine 600 having two stages, namely, transmission mode 605 and configuration mode 610. In transmission mode 605, the mode evaluator 405 may conduct periodic link quality assessment. The periodicity may be low for static environments, high for mobile environments, or dynamically adjusted based on history. If the mode evaluator 405 determines that there is no change in link quality, then the mode evaluator 405 remains in the transmission mode 605. If the mode evaluator 405 determines that there is a change in link quality, then the mode evaluator 405 jumps to the configuration mode 610 to determine whether a different mode of communication would be preferred (e.g., per the criteria). When mode selection is complete, mode evaluator 405 returns to the transmission mode 605.

As can be seen, should conditions (e.g., environmental, geographic, etc.) change, e.g., changes in the link conditions, a mode change may be initiated. For example, if a source station is a mobile device that moves into closer range with its sink station, then the preferred link may change from an access point communication to direct access communication. Runtime link assessment may be different because of power requirements or execution complexity requirements. Other state machine embodiments are also possible.

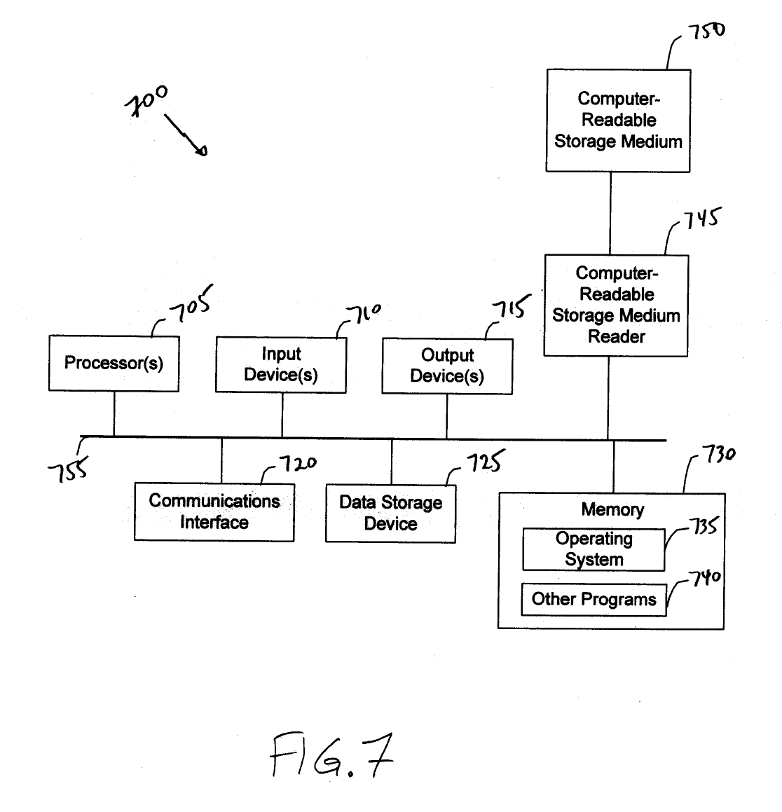

FIG. 7 is a block diagram illustrating details of an example computer system 700. Computer system 700 includes a processor 705, such as an Intel Pentium® microprocessor or a Motorola Power PC® microprocessor, coupled to a communications channel 755. The computer system 700 further includes an input device 710 such as a keyboard or mouse, an output device 715 such as a cathode ray tube display, a communications device 720, a data storage device 725 such as a magnetic disk, and memory 730 such as Random-Access Memory (RAM), each coupled to the communications channel 755. The communications interface 720 may be coupled to a network such as the wide-area network commonly referred to as the Internet. One skilled in the art will recognize that, although the data storage device 725 and memory 730 are illustrated as different units, the data storage device 725 and memory 730 can be parts of the same unit, distributed units, virtual memory, etc.

The data storage device 725 and/or memory 730 may store an operating system 735 such as the Microsoft Windows NT or Windows/95 Operating System (OS), the IBM OS/2 operating system, the MAC OS, or UNIX operating system and/or other programs 740. It will be appreciated that a preferred embodiment may also be implemented on platforms and operating systems other than those mentioned. An embodiment may be written using JAVA, C, and/or C++ language, or other programming languages, possibly using object oriented programming methodology.

One skilled in the art will recognize that the computer system 700 may also include additional information, such as network connections, additional memory, additional processors, LANs, input/output lines for transferring information across a hardware channel, the Internet or an intranet, etc. One skilled in the art will also recognize that the programs and data may be received by and stored in the system in alternative ways. For example, a computer-readable storage medium (CRSM) reader 745 such as a magnetic disk drive, hard disk drive, magneto-optical reader, CPU, etc. may be coupled to the communications bus 755 for reading a computer-readable storage medium (CRSM) 750 such as a magnetic disk, a hard disk, a magneto-optical disk, RAM, etc. Accordingly, the computer system 700 may receive programs and/or data via the CRSM reader 745. Further, it will be appreciated that the term “memory” herein is intended to cover all data storage media whether permanent or temporary.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed:

1. A method for selecting a communication mode in a wireless local area network, comprising:
evaluating a first attribute of an access point communication mode between a source device and a sink device;
evaluating a second attribute of a direct access communication mode between the source device and the sink device; and
selecting one of the access point communication and the direct access communication based on the evaluation results.

2. The method of claim 1, wherein at least one of the access point communication mode or the direct access communication mode uses an 802.11e standard.

3. The method of claim 1, wherein the first attribute and the second attribute are the same attribute.

4. The method of claim 1, wherein at least one of the first attribute and the second attribute includes throughput rate.

5. The method of claim 1, wherein at least one of the first attribute and the second attribute includes jitter.

6. The method of claim 1, wherein at least one of the first attribute and the second attribute includes delay.

7. The method of claim 1, wherein at least one of the first attribute and the second attribute includes power use.

8. The method of claim 1, wherein at least one of the first attribute and the second attribute includes noise.

9. The method of claim 1, wherein at least one of the first attribute and the second attribute includes cost.

10. A system for selecting a communication mode in a wireless local area network, comprising:
a mode evaluator for evaluating a first attribute of an access point communication mode between a source device and a sink device, evaluating a second attribute of a direct access communication mode between the source device and the sink device, and selecting one of the access point communication mode and the direct access communication mode based on the evaluation results; and
configuration information for using the selected mode.

11. The system of claim 10, wherein at least one of the access point communication mode or the direct access communication mode uses an 802.11e standard.

12. The system of claim 10, wherein the first attribute and the second attribute are the same attribute.

13. The system of claim 10, wherein at least one of the first attribute and the second attribute includes throughput rate.

14. The system of claim 10, wherein at least one of the first attribute and the second attribute includes jitter.

15. The system of claim 10, wherein at least one of the first attribute and the second attribute includes delay.

16. The system of claim 10, wherein at least one of the first attribute and the second attribute includes power use.

17. The system of claim 10, wherein at least one of the first attribute and the second attribute includes noise.

18. The system of claim 10, wherein at least one of the first attribute and the second attribute includes cost.

19. A system for selecting a communication mode in a wireless local area network, comprising:
means for evaluating an attribute during access point communication between a source device and a sink device;
means for evaluating the attribute during direct access communication between the source device and the sink device; and
means for selecting one of the access point communication and the direct access communication based on the evaluation results.
